(19) United States
(12) Patent Application Publication
(10) Pub. No.: US 2023/0363614 A1
(43) Pub. Date: Nov. 16, 2023

(54) Pointed Prostrate Cleaning Device

(71) Applicant: Shizuko Nakajima, Astoria, NY (US)

(72) Inventor: Shizuko Nakajima, Astoria, NY (US)

(21) Appl. No.: 17/742,804

(22) Filed: May 12, 2022

(51) Int. Cl. A47L 13/254; A47L 13/44

(52) U.S. Cl. CPC A47L 13/254; A47L 13/44

(57) ABSTRACT

A pointed prostrate cleaning device for cleaning low profile areas includes a base having a top surface and a bottom surface. The base has a tip and the top surface has a pair of buttons. A proximal end of a handle has a strap. The strap has a pair of ends and a pair of snaps is positioned on a respective one of the pair of ends of the strap. The pair of snaps engages by snap button fastening to the pair of buttons of the base. A mop has a cleaning surface and an attaching surface with a point. The point has a cavity positioned on the attaching surface of the mop. The cavity defines a space for the tip of the base to be nested within. A plurality of bumps is positioned on the cleaning surface of the mop.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to cleaning handle device and more particularly pertains to a new cleaning handle device for cleaning low profile areas.

### (2) Description of Related Art Including Information Disclosed Under 37 CFR 1.97 and 1.98

The prior art relates to cleaning handle devices. The prior art relates to a variety of cleaning handle devices having a detachable handle from the cleaning device. Furthermore, the prior art relates to a variety of cleaning handle devices to clean isolated areas. Known prior art lacks a cleaning handle device having a point to facilitate in cleaning isolated areas.

### BRIEF SUMMARY OF THE INVENTION

An embodiment of the disclosure meets the needs presented above by generally comprising a base having a top surface and a bottom surface. The base has a tip and the top surface has a pair of buttons. A handle has a distal end and a proximal end relative to the base. The proximal end of the handle has a strap. The strap has a pair of ends and a pair of snaps is positioned on a respective one of the pair of ends of the strap. The pair of snaps is configured for engaging by snap button fastening to the pair of buttons of the base. A mop is configured for being saturated in sanitation fluids. The mop has a cleaning surface and an attaching surface. The mop has a point and the point has a cavity positioned on the attaching surface of the mop. The cavity defines a space for the tip of the base to be nested within. A plurality of bumps is positioned on the cleaning surface of the mop.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric view of a pointed prostrate cleaning device according to an embodiment of the disclosure.

FIG. 2 is an exploded view of an embodiment of the disclosure.

FIG. 3 is a bottom view of an embodiment of the disclosure.

FIG. 4 is a top view of an embodiment of the disclosure.

FIG. 5 is a front view of an embodiment of the disclosure.

FIG. 6 is a back view of an embodiment of the disclosure.

FIG. 7 is an in-use side view of an embodiment of the disclosure.

### DETAILED DESCRIPTION OF THE INVENTION

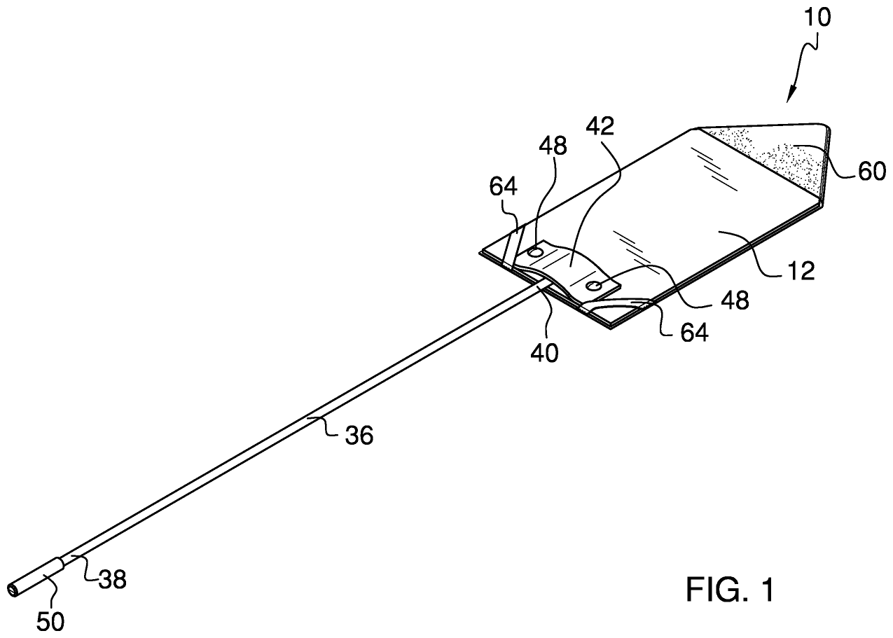

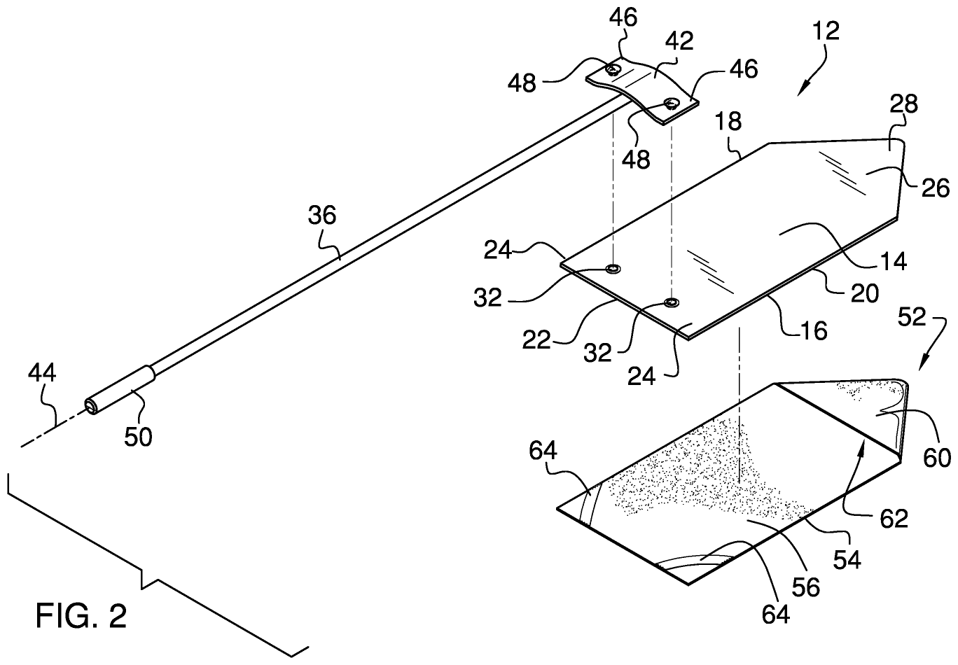

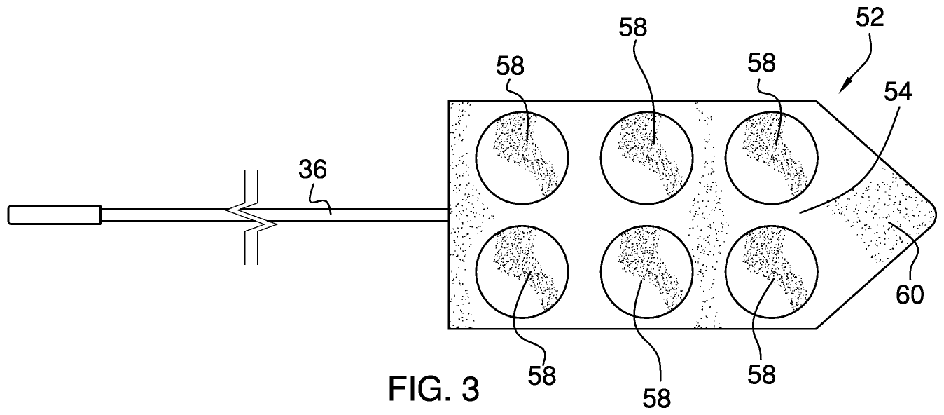

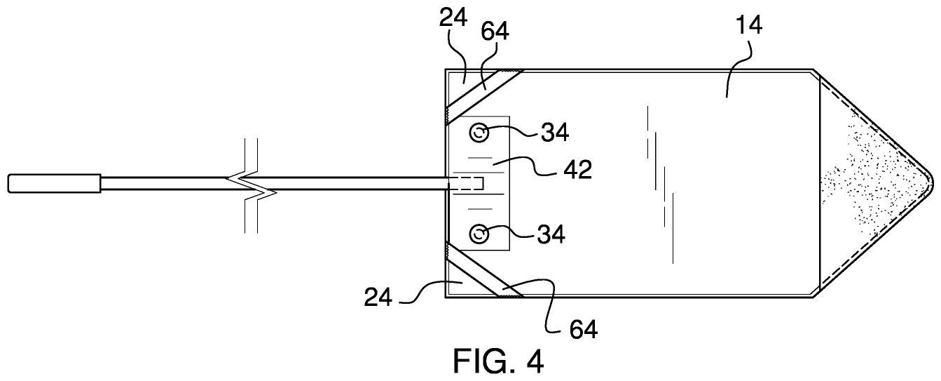

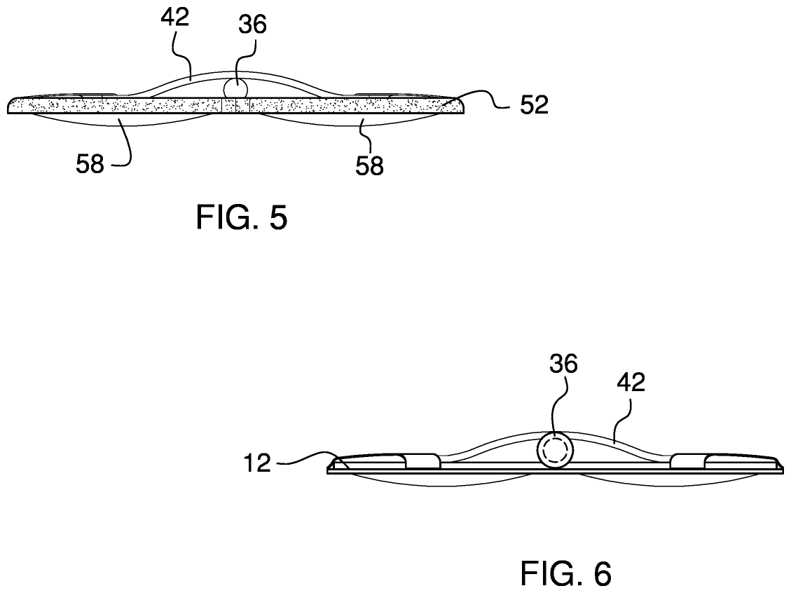

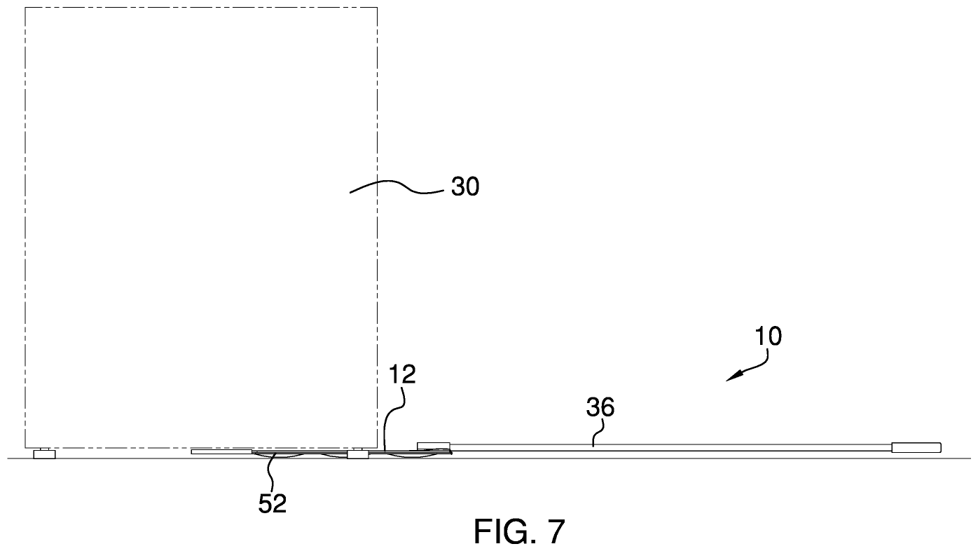

With reference now to the drawings, and in particular to FIGS. 1 through 7 thereof, a new cleaning handle device embodying the principles and concepts of an embodiment of the disclosure and generally designated by the reference numeral 10 will be described.

As best illustrated in FIGS. 1 through 7, the pointed prostrate cleaning device 10 generally comprises a base 12. The base 12 has a top surface 14 and a bottom surface 16. The base 12 has a left edge 18 and a right edge 20 being positioned parallel relative to each other. The base 12 has a back edge 22 positioned perpendicular relative to the left 18 and right 20 edges. The back edge 22 of the base 12 has a pair of corners 24. Furthermore, the base 12 has a tip 26. The tip 26 has a triangular shape 28 and is positioned parallel relative to the back edge 22. The triangular shape 28 of the tip 26 is configured for facilitating in reaching corners of the floor 56 under an appliance 30. Additionally, the top surface 14 has a pair of buttons 32. The pair of buttons 32 is positioned proximate to the back edge 22 of the base 12. The pair of buttons 32 is a first portion of a snap button fastener 34.

A handle 36 has a distal end 38 and a proximal end 40 relative to the base 12. The proximal end 40 of the handle 36 has a strap 42 being positioned on an exterior of the handle 36. The strap 42 is positioned perpendicular relative to an axis 44 of the handle 36. The strap 42 has a pair of ends 46 with a pair of snaps 48 positioned on a respective one of the pair of ends 46. The pair of snaps 48 is a second portion of the snap button fastener 34 thus the pair of snaps 48 is configured for engaging by snap button fastening to the pair of buttons 32 of the base 12. Furthermore, the distal end 38 of the handle 36 has a grip 50 configured for being grasped by the user.

A mop 52 is configured for being saturated in sanitation fluids to cleanse the surface the mop 52 slides upon. The mop 52 has a cleaning surface 54 and an attaching surface 56. The attaching surface 56 is configured for abutting the bottom surface 16 of the base 12. The cleaning surface 54 is configured to wipe across the floor 56. The cleaning surface 54 has a plurality of bumps 58 with each of the bumps 58 being a convex shape. The mop 52 has a point 60 being triangular, similar to the tip 26 of the base 12. The point 60 has a cavity 62 positioned on the attaching surface 56 of the mop 52, thus the cavity 62 defines a space for the tip 26 of the base 12 to be nested within. A pair of bands 64 is positioned on the attaching surface 56 of the mop 52. The pair of bands 64 is configured for securing to a respective one of the pair of corners 24 of the back edge 22 of the base 12. The pair of bands 64 and the cavity 62 of the point 60 of the mop 52 helps retain the mop 52 to the base 12.

In use, the pair of snaps 48 of the strap 42 of the handle 36 can be secured to the pair of buttons 32 of the base 12 by the snap button fastener 34. When the handle 36 is attached to the base 12, the mop 52 can be secured to the base 12 by nesting the tip 26 of the base 12 within the cavity 62 of the point 60 of the mop 52. Additionally, the pair of bands 64 of the mop 52 can secure to the pair of corners 24 of the back edge 22 of the base 12 to provide supplementary securement. The plurality of bumps 58 of the mop 52 facilitate in cleansing the floor 56 as the cleaning surface 54 of the mop 52 glides upon the floor 56. The handle 36 can be used to extend the mop 52 underneath inaccessible areas under an appliance 30. The tip 26 of the base 12 can reach the point 60 of the mop 52 to corners of the floor 56 and other areas unreachable without the tip 26 of the base 12. When use is complete, the mop 52 can be removed from the base 12 for washing.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A low profile cleaning device configured for mopping underneath appliances with inaccessible surfaces, the device comprises:
a base having a top surface and a bottom surface, the base having a tip, the top surface having a pair of buttons, the base having a back edge;
a handle having a distal end and a proximal end relative to the base, the proximal end of the handle having a strap, the strap having a pair of ends, a pair of snaps being positioned on a respective one of the pair of ends of the strap, the pair of snaps being configured for engaging by snap button fastening to the pair of buttons of the base, the strap being elongated, the handle extending from a longitudinal edge of the strap, the longitudinal edge of the strap from which the handle extends being positioned abutting and extending along the back edge of the base; and
a mop being configured for being saturated in sanitation fluids, the mop having a cleaning surface and an attaching surface, the mop having a point, the point having a cavity positioned on the attaching surface of the mop, the cavity defining a space for the tip of the base to be nested within, a plurality of bumps being positioned on the cleaning surface of the mop.

2. The low profile cleaning device of claim 1, further comprising the base having a left edge and a right edge being positioned parallel relative to each other.

3. The low profile cleaning device of claim 2, further comprising the back edge being positioned perpendicular relative to the left and right edges, the back edge of the base having a pair of corners.

4. The low profile cleaning device of claim 3, further comprising the tip having a triangular shape, the tip being parallel relative to the back edge.

5. The low profile cleaning device of claim 3, further comprising the pair of buttons being positioned proximate to the back edge, the pair of buttons being a first portion of a snap button fastener.

6. The low profile cleaning device of claim 1, further comprising the strap being positioned on an exterior of the handle, the strap being positioned perpendicular relative to an axis of the handle.

7. The low profile cleaning device of claim 5, further comprising the pair of snaps being a second portion of the snap button fastener.

8. The low profile cleaning device of claim 1, further comprising the distal end of the handle having a grip, the grip being configured for being grasp by the user.

9. The low profile cleaning device of claim 1, further comprising the point being triangular.

10. The low profile cleaning device of claim 3, further comprising the mop having a pair of bands, the pair of bands positioned on the attaching surface of the mop, the pair of bands being configured for securing to a respective one of the pair of corners of the back edge of the base.

11. The low profile cleaning device of claim 1, further comprising each of the bumps being a convex shape.

12. A low profile cleaning device configured for mopping underneath appliances with inaccessible surfaces, the device comprises:
a base having a top surface and a bottom surface, the base having a left edge and a right edge being positioned parallel relative to each other, the base having a back edge, the back edge being positioned perpendicular relative to the left and right edges, the back edge of the base having a pair of corners, the base having a tip, the tip having a triangular shape, the tip being parallel relative to the back edge, the top surface having a pair of buttons, the pair of buttons being positioned proximate to the back edge, the pair of buttons being a first portion of a snap button fastener;
a handle having a distal end and a proximal end relative to the base, the proximal end of the handle having a strap, the strap being positioned on an exterior of the handle, the strap being positioned perpendicular relative to an axis of the handle, the strap having a pair of ends, the strap being elongated the handle extending from a longitudinal edge of the strap, the longitudinal edge of the strap from which the handle extends being positioned abutting and extending along the back edge of the base, a pair of snaps being positioned on a respective one of the pair of ends of the strap, the pair of snaps being a second portion of the snap button fastener, the pair of snaps being configured for engaging by snap button fastening to the pair of buttons of the base, the distal end of the handle having a grip, the grip being configured for being grasp by the user; and
a mop being configured for being saturated in sanitation fluids, the mop having a cleaning surface and an attaching surface, the mop having a point, the point being triangular, the point having a cavity positioned on the attaching surface of the mop, the cavity defining a space for the tip of the base to be nested within, the mop having a pair of bands, the pair of bands positioned on the attaching surface of the mop, the pair of bands being configured for securing to a respective one of the pair of corners of the back edge of the base, a plurality of bumps being positioned on the cleaning surface of the mop, each of the humps being a convex shape.
